(19) United States
(12) Patent Application Publication
(10) Pub. No.: US 2002/0188500 A1
(43) Pub. Date: Dec. 12, 2002

(54) System for managing oil and gas exploration and production data and related transactions

(76) Inventors: Shui Hung Kwok, Calgary (CA); Dimitris Agouridis, Calgary (CA)

Correspondence Address: BLAKELY, SOKOLOFF, TAYLOR & ZAFMAN LLP, Seventh Floor, 12400 Wilshire Boulevard, Los Angeles, CA, 90025-1026, US

(21) Appl. No.: 10/020,487

(22) Filed: Oct. 29, 2001

Related U.S. Application Data
(60) Provisional application No. 60/243,712, filed on Oct. 30, 2000.
(60) Provisional application No. 60/243,713, filed on Oct. 30, 2000.
(60) Provisional application No. 60/243,714, filed on Oct. 30, 2000.

(51) Int. Cl. G06F 17/60

(52) U.S. Cl. 705/10; 345/757

(57) ABSTRACT

The invention relates to a system for managing exploration and production data within the oil and gas industry. In particular, the invention relates to a system for granting access to the data for assisting in transactions relating to the data.

### CROSS REFERENCE TO RELATED APPLICATIONS

This application claims the benefit of U.S. Provisional Application Nos. 60/243,712, 60/243,713 and 60/243,714, all filed Sep. 1, 2000.

### FIELD OF THE INVENTION

The invention relates to a system for managing exploration and production data within the oil and gas industry. In particular, the invention relates to a system for granting access to the data for assisting in transactions relating to the data.

### BACKGROUND OF THE INVENTION

As is known the business cycle within the oil industry (the “Industry”) can be described to include exploration and production, each with associated tasks and functions for ultimately taking product to market. The Industry is characterized by worldwide operations that are undertaken on land and marine areas, at both remote and accessible locations and by parties ranging in size from individuals to multi-national corporations.

Another characteristic of the Industry is that commodity prices and market demand/supply are subject to dramatic swings largely outside the control of the Industry which result in boom and bust cycles within the Industry. Boom and bust cycles generally drive the activity levels in the Industry; for example, exploration activity generally accelerates when higher commodity prices exist or are anticipated and merger and acquisition activity also follows these cycles to some degree.

Active exploration for oil and gas typically starts with the acquisition of raw seismic data, which is then processed and interpreted in an effort to identify underground reservoirs that can be exploited to bring the oil and gas to the surface in quantities sufficient to take to market on a profitable basis. Profitability is sometimes difficult to predict due to production and market uncertainties aggravated by the long timelines typically involved between exploration and payment from the ultimate customer for the oil and gas found and produced.

Seismic data can have significant value, by virtue of the cost of acquiring data and that data can be sold and resold to purchasers who are speculating that it will help them target untapped reserves underground and obtain profits from the sale of oil and gas or rights to the oil and gas located there. Target exploration properties are bought and sold as “prospects”, in whole or fractional interests, based upon the rights involved.

Successful exploitation of underground reserves cannot take place until those reserves are pinpointed and exploration drilling successfully taps the reservoir. Very little can be considered certain in this process despite the sophisticated efforts of geophysicists and geologists in their processing and interpretation of the seismic data. As a result, the Industry can expend substantial resources in the search for oil and gas and not actually find anything. Once found, reserves of marketable size then await development which includes extracting the oil/gas from the reservoir, refining as necessary and ultimately transporting it to market.

The stakes during the exploration and production phases are particularly high. Mistakes and failures can be extremely costly but similarly, on the other hand, potential profits can be substantial if the exploration and production is successful.

In view of the potential risks, it is common in the Industry for the participants (on both the exploration and development sides) to adopt risk-sharing strategies, including partnerships, pooling and joint ventures. These arrangements can take place at almost any stage from exploratory ventures to the sale of developed reserves thereby forming “intermediate transactions” through which parties completely or partially enter or exit a venture.

In order to find partners to share the costs and risks of a venture, the participants in the Industry accumulate and share information gathered along the way about the prospects and properties. Until very recently, most of this information (including raw seismic data, processed and interpreted seismic data, exploration results, well testing and production results, engineering reports, financial and other analyses) has been maintained and archived in a physical format, principally on magnetic tapes, microfiche and paper documents.

Only in recent years has the information been converted to electronic format in any significant way (and digital information is still a much less common format than physical counterparts).

The fact that most of the relevant information is held in a physical format means that in order to share the information it must be physically exchanged between the interested parties. The difficulty of such physical exchanges of information is a result of the volume of information which may include many of the above documents with information relating to a particular property. In the result, the sheer physical undertaking to compile, transport and review information amongst interested parties can be physically cumbersome, costly and time-consuming.

With respect to the transportation of information, rather than have multiple copies of often proprietary information around, the Industry will commonly use what is known as a data room. A data room is a physical secure room in a particular location to which access can be granted to various parties to enable their review of information. One of the key limitations of a data room is that unless the information is duplicated and multiple rooms established (which in itself is a costly and time-consuming process), the information can usually only be viewed by one party at a time.

It is also important to note that before a data room is set up, the provider or seller of information needs to find a way to attract interested parties (or potentially interested parties) into the process. The seller may undertake marketing efforts themselves or utilize the services of “data brokers” who act as agents in the purchase and sale of data. In the past, data brokers have been constrained by the physical bottlenecks in the process with respect to data rooms and access to those rooms by more than one client.

A further difficulty in the process relates to security. That is, the owner of information does not want it to be accessed or duplicated for any unauthorized purpose as this might undermine the value of the information and its selling price. Confidentiality and security enhances the owner's ability to control the market and, correspondingly, gives assurance to the buyer that the information has retained its value.

With respect to confidentiality, at times the parties involved might wish to operate “blind” where their identity remains confidential for competitive or other reasons. Clearly, the more physical contact between parties to a transaction, the less likely it is that confidentiality can be maintained. Confidentiality is another reason why data brokers are useful intermediaries.

Timeliness is also a factor in the Industry, as in other business sectors. Notwithstanding the long timelines from exploration to market, the parties need to be able to act quickly on opportunities. This is most dramatically shown in relation to purchase/sale transactions where a buyer often needs to evaluate relevant information (through processing, interpretation, or other analyses) as they are evaluating a prospect or property, and they need to do so quickly in order that an opportunity is not lost to another buyer.

The parties in the Industry may have their own evaluation teams in-house, or may outsource those functions to expert consultants and advisors. As a result of the cycles inherent in the Industry (based upon cyclical swings in commodity prices and supply/demand), corporate downsizing has caused the conversion of many professionals from employee to independent contractor. In the result, involvement of third party service or product providers, including expert consultants/advisors, is not only helpful but also often critical in the Industry.

Technology has at times provided assistance to the Industry on both the exploration side and production side. However, in the past, there has been a need for a technology enabling the integration of oil office or data room capabilities into a unified package which addresses the above issues including data publication and processing, marketing, security, transaction, confidentiality, timeliness in the context of multi-party involvement.

More specifically, there has been a need for a system enabling a variety of functions including viewing industry data including seismic data and other information relating to any geographical area (prospect or property), manipulating exploration and production data and information, transmission of data and information in a secure manner between interested parties, effective and efficient storage of data and information and providing access to various product and service providers in a secure and confidential manner if required.

In addition, there has been a need for a system that is implemented in an efficient manner where up-front capital costs, and general and administrative costs are reduced.

### SUMMARY OF THE INVENTION

In accordance with the invention, there is provided a system for managing oil and gas industry data and granting a user access to the industry data over a network comprising:

a database within at least one server operatively connected to the network, the

database containing industry data from at least one customer;

a system administration module for granting the user access rights to a customer's industry data, wherein the user can access a customer's industry data across the network upon being granted access rights by the system administration module.

In a preferred embodiment, the system is an internet portal and website, the website including a home page module having operative links to the database and the system administration module. It is also preferred that the website include links to various modules having a variety of functions. These include a virtual client room module that enables a customer's industry data to be graphically located in a specific location on the website, and a project management enabling a customer to access project management software to control access by third parties and to monitor third party access to the industry data through the system administration module.

It is also preferred that the system administration module includes at least two levels of access security including a public access level enabling public access to public industry data without system registration and a first access level enabling user access to specific industry data only after system registration. A third level of access security can also be provided enabling user access to a customer's industry data after the customer grants access approval to the user, normally after a user has completed a financial transaction with the customer.

The system may also include industry data viewing and processing software operatively connected to the system to enable a user having access rights to view or process the industry data from a remote location across the network. In addition, the system may be operatively linked to any one of or a combination of data software modules including data management, data mapping, data processing, data processing and data viewing software, a virtual client room module, a project management module, a resource module, a business floor module and third party modules including any one of or a combination of professional services, technical services and financial services.

In one embodiment, the data software modules are remote to the system and a customer or user can access a specific data software module on a pay per use basis.

In a further embodiment, the system administration module does not identify the identity of parties prior to the completion of a transaction (or at all) and/or may enable multiple parties to access industry data within a virtual client room module simultaneously. The system administration module may also act as an intermediary in a financial transaction between a customer and user.

In a more specific embodiment, the invention provides a system for promoting the electronic exchange of oil and gas industry data and the completion of transactions within the oil industry across the internet, comprising:

a website having a database in at least one server operatively connected to the internet, the database containing industry data from at least one customer;

a system administration module operatively connected to the website for granting a potential buyer access rights to a customer's industry data, wherein the potential buyer can access a customer's industry data across the internet upon being granted access rights by the system administration module, the system administration module defining at least three levels of access security including a first access level enabling public access to public industry data without system registration, a second access level enabling a potential buyer access to specific industry data only after system registration and a third level of access security enabling the potential buyer access to a customer's industry data after the customer grants access approval to the user upon completion of a financial transaction.

### BRIEF DESCRIPTION OF THE DRAWINGS

Preferred embodiments of the present invention will now be described, by way of example only, with reference to the attached Figures, wherein:

FIG. 1 is a schematic overview of a data system deployed over the internet in accordance with one embodiment of the invention;

FIG. 2 is a schematic diagram of a home page module and links in accordance with one embodiment of the invention;

FIG. 3 is a schematic diagram of a software application module and links in accordance with one embodiment of the invention;

FIG. 4 is a schematic diagram of a project administration module and links in accordance with one embodiment of the invention;

FIG. 5 s a schematic diagram of a virtual client room module and links in accordance with one embodiment of the invention; and,

FIG. 6 is a schematic diagram of a business floor module and links in accordance with one embodiment of the invention.

### DETAILED DESCRIPTION OF THE INVENTION

With reference to the Figures, a data system 10 is described providing data management and processing capabilities for the effective operation of particular activities relating to the Industry. In particular, a system is described in which parties to the Industry can come together at any stage of the exploration and production phases to view, share and work collaboratively on data and information (“data”) within the system workplace to buy and sell prospects and properties; form binding contracts; transfer data, information and payments wherein these activities are conducted either locally or remotely in a secure environment.

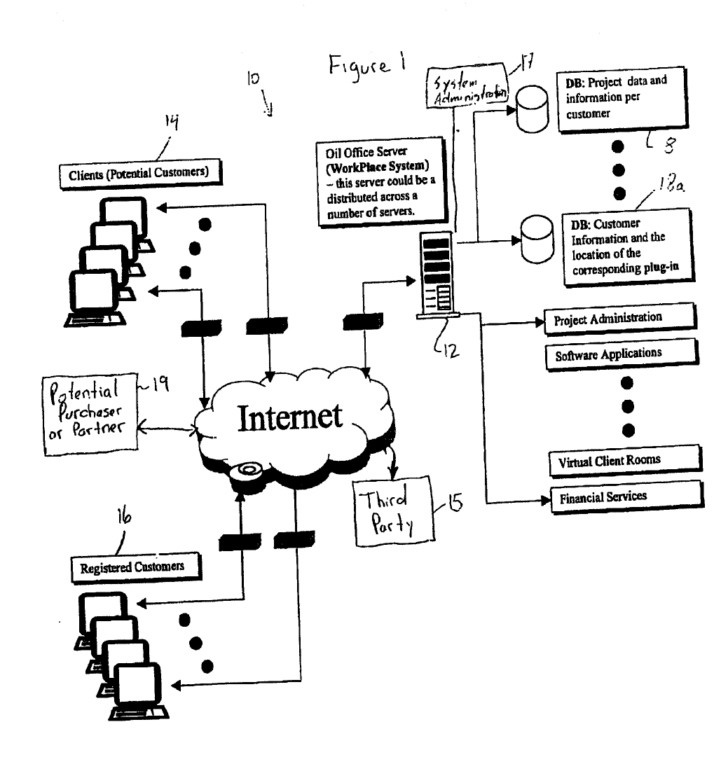

With reference to FIG. 1, a server(s) 12 hosts the data system allowing users including clients or potential customers 14, registered customers 16, third party product or service providers 15 and/or potential purchasers or partners 19 to access the data system 10 over the Internet or other network. Behind or within the server 12, various databases and software applications and modules are provided to provide the overall system functionality. In a preferred embodiment, as herein described, the system is deployed allowing access to the server(s)12 over the Internet.

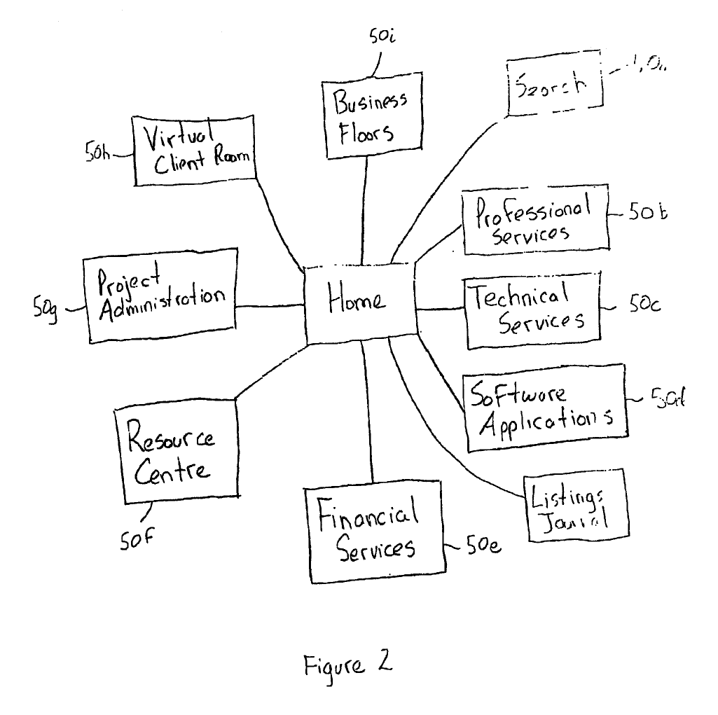

Upon gaining access to the system home page module (FIG. 2), users can access further system modules which promote the exchange of information between parties thus defining a virtual office. Importantly, the ability of a user to gain access to specific system areas will be determined by the level of authorization granted by a system administration module 17 and system administrator. The system administrator through the system administration module 17 will grant access based on specific or negotiated agreements between the administrator and specific parties and/or agreements between specific parties.

Specific modules within the system may include modules enabling searching 50a, access to professional services 50b, access to technical services 50c, access to data processing or data viewing software applications 50d and financial services 50e. In addition, other modules may include resource modules 50f, project administration modules 50g, virtual client room modules 50h and/or business floor modules 50i.

Each module of the website is preferably enabled with point and click functionality, such that once information is loaded and the relevant parties provided access, there is no need for human interaction until there is actual negotiation of terms relating to a purchase/sale and input from the system administrator is required to grant access privileges.

With reference to FIGS. 2-6, the functionality of the system modules accessible from the home page module is described.

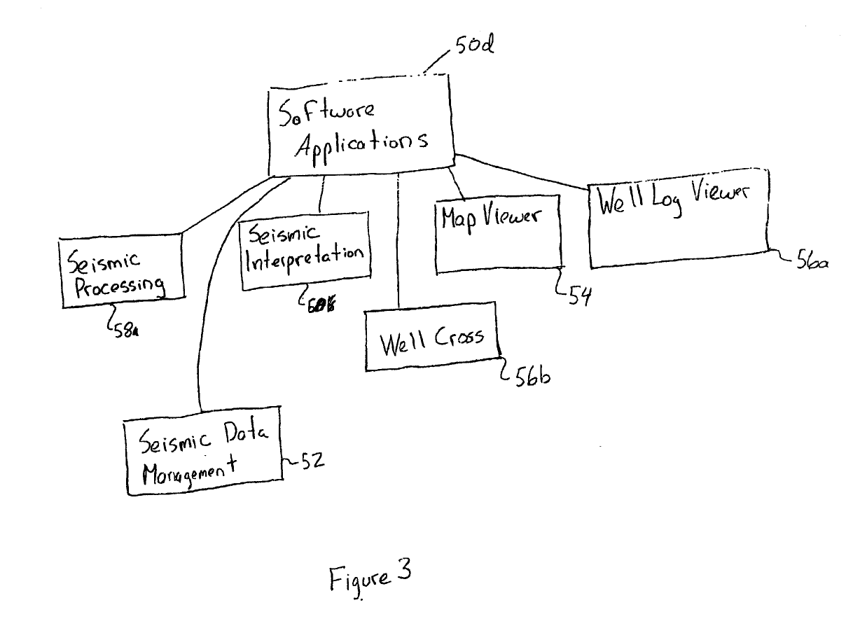

With reference to FIG. 3, the user may access software applications 50d allowing a variety of industry data viewing and processing capabilities.

Data Management 52

Data in a physical format is scanned and transferred to a digital form which then allows the data to be readily stored and accessed in database 18. Data may be converted to a digital form by the owners or by a service provider.

Data management software algorithms used in the Industry can be ported to the system to allow users to access and manipulate data online from either a single or from multiple locations.

An example of data management software is “Olympus DMS Data Management System”. The Olympus DMS Data Management System (SYNER-SEIS Technologies Inc.) is designed to operate on a local area network or over the Internet, as a hosted system, featuring two-way communication and optional seismic data mapping and viewer modules. The data is held in SEGY and SEGP formats. The system can accommodate multiple end-users simultaneously; each of the mapping and viewing modules can instigate searches and queries through the system, which in turn transmits the requested information through the database and can allow for queries and searches from remote locations.

The software can also accommodate and integrate other Internet compatible data management systems, to offer the user an array of systems, preferably on a pay-per-use basis.

Data Mapping 54

Data mapping software algorithms used in the Industry can be ported to the system to allow users to view seismic data in relation to geographical maps, allowing for enhanced data management functionality.

Preferably, the user can direct information inquiries by region or sub-region and link to data gathered in relation to the specified area, for example, by cross-referencing by data source/owner or other identifier.

Data comparisons are available by links within the data maps, allowing the user to access and view data from different sources to determine and compare quality, value and other attributes.

An example of suitable data mapping software is “Olympus Geographical Information Mapping System”.

The Olympus Geographical Information Mapping System (SYNER-SEIS Technologies Inc.) is designed to facilitate data management through geographical coordinates. Data is held in SEGP-1 format.

Third party data mapping systems can be ported to the system preferably converted to JAVA or another Internet compatible format.

Data Viewers 56a, 56b

Data viewing software used in the Industry can be ported to the system to allow users to view seismic exploration data from specific viewers, including Well Log Viewer and SEGY viewer.

The well log viewer allows for users to examine well log data in visual format and to view the data simultaneously with other parties if desired. The SEGY viewer allows the user to see seismic data in various processed and non-processed formats with customization as desired to suit specific user's needs. In particular, specific JAVA applets enable the user to zoom in or out of areas of interest.

Data can be hosted in a variety of ways. In one embodiment, data can be transferred to the system database 18 by the user in order that the services and/or products of third party service providers can be utilized in respect of the data. This allows the user to process and interpret their data for future evaluation, use, sale or other objective. Preferably, the system utilizes secure file transfer technology for data transfer as described in greater detail below.

In another embodiment, data viewers can be transferred to a user's system upon request. In this embodiment, a data directory is attached by the user and data images can then be created online, without the need for the data to be hosted on the server 12. This embodiment thereby enables the user to create their own data website and make data conversions online, from their remote system.

An example of suitable data viewing software is “Olympus SDV Seismic Data Viewer” and “Olympus WLV Well Log Viewer”.

The Olympus SDV Seismic Data Viewer (SYNER-SEIS Technologies Inc.) is designed to display “pre-stack” and “post-stack” seismic data in the industrial standard format SEGY. The program supports a variety of plot options, such as variable density, filled wiggles, and colour display, and can display trace header information in SEGY or a customized format.

The Olympus WLV Well Log Viewer (SYNER-SEIS Technologies Inc.) is a tool designed to allow the user to view well curves (exploration or production wells). The program reads in LAS standard format, thus eliminating internal formatting issues. The program is capable of performing both time to depth conversion and creating synthetic traces using either a sonic curve alone or both a sonic and depth curve.

Data Processing 58

Data processing of seismic data can be accomplished by accessing system or third party processing applications, preferably on a pay per use basis. In this embodiment, the user either downloads the software to a remote system 16 or transfers data to the system server 12 through the secure file transfer system. If data is loaded to the system server 12, the user can either control the data processing themselves or access third party services for that purpose.

Third party processing applications which can be ported to the system may include industry standard software applications, which have been preferably converted to JAVA or another Internet compatible format.

Data Interpreation 60

Interpretation of seismic data can be accomplished by accessing system or third party interpretation algorithms, preferably on a pay per use basis. In this embodiment, the user either downloads the software to their remote system or transfers the data to the portal workplace through the secure file transfer system. If data is loaded to the system server 12, the user can either control the data interpretation themselves or access third party services for that purpose.

In one embodiment, specialized JAVA applets are utilized to select data segments for interpretation from the SEGY format. The system also facilitates the application of other analytical process/software for other analyses including financial or engineering analyses.

Third party seismic data interpretation applications which can be ported may include industry standard software applications which have preferably been converted to JAVA or another compatible format. The functionality of the JAVA applets on the system may include seismic event picking (various options), seismic velocity definition (manual or interactive), and/or seismic event flattening.

Data Transfer

Encryption algorithms are preferably utilized to enable secure transfer of data online. Third party secure socket layer technology is preferably incorporated into the system. Preferably, the encryption technology is based upon the industry standard Sun Microsystems JAVA Secure Sockets Extension technology (so called “Secure Sockets Layer”, or SSL). The SSL employed by the system implements encryption and also server and client authentication based on public key signatures and digital certificates. The system may incorporate specific data transfer technology based upon standard encryption algorithms; and is preferably written in JAVA.

Project Management

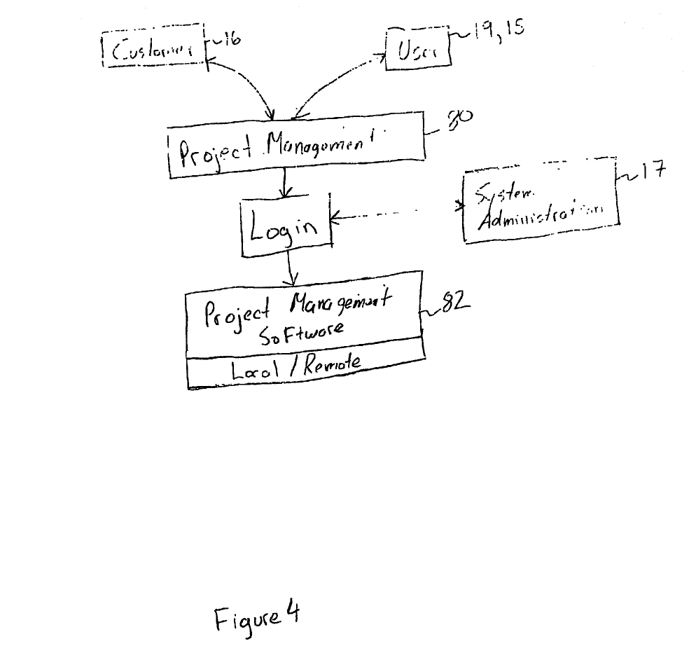

With reference to FIG. 4, project management is facilitated by virtue of the multi-user and multi-use functionality. Project management software 82 can be accessed from the system or from third party service and product providers. In this regard, the system enables a portion of the system server 12 to be dedicated to a particular user upon request by a customer 16 or user 19, 15 for project management purposes. Access to project management software 82 will controlled by the system administration module 17 through a login process and may be located remotely or locally.

For example, a user may wish to in whole or in part evaluate a prospect, purchase all or part of that prospect, explore for oil and gas based on the prospect data, incorporate subsequent exploration data into existing data whether to take the exploration prospect to production phase, add production data to existing data and then market the property. Each of these phases can consist of an intermediate transaction or a series of intermediate transactions between interested parties, who may wish to be involved in a collaborative basis at various times. The system 12 facilitates the collaboration between parties by enabling several parties to work together from remote locations and have current information and communication at all stages.

For example, in respect of an exploration joint venture between two parties (A and B), the parties would share the existing and new data through the system in a secure fashion, storing the data on the system in a client room to which only those parties have access (such access being controlled by the system administrator pursuant to the agreement with the parties). The exploration activities (drilling of exploration wells) will generate new data, which can be sent online to the client room and added to the existing data. The evaluation of all of the data may involve geologists and other specialists from each of the parties, each of whom will have equal access to the data within the client room. The transparency of the process within the client room facilitates the joint venture, through the assurance that it gives to each of the parties as to their knowledge and involvement, through collaborative evaluation and decision making, and through timely exchange of inputs/outputs (data and otherwise).

Access

As indicated above, access is controlled to varying degrees, depending on the instructions of the data owner/seller and functionality (level of access) required. Access is preferably controlled by a registration process wherein the system administration module and system administrator assigns a particular access code to each registrant and thus allows both for pre-screening of registrants and provides limitations on access and use.

Registration is required for secured access to all levels beyond general public access. Registration information is stored in a database 18a which also forms an electronic marketplace for Industry participants (sellers, buyers, service and product providers, etc.). Registration preferably is conducted on-line, with agreements containing specified terms and conditions of access and use as part of the registration which thereby sets a structure within which transactions can occur and which safeguards the interests of all parties.

The access codes enable confidentiality and, if required, also allows for assured e-commerce transactions during any purchase/sale transaction. For example, creditworthiness can be pre-established, and business information can be shared between parties in a confidential and secure manner.

Virtual Client Rooms 70

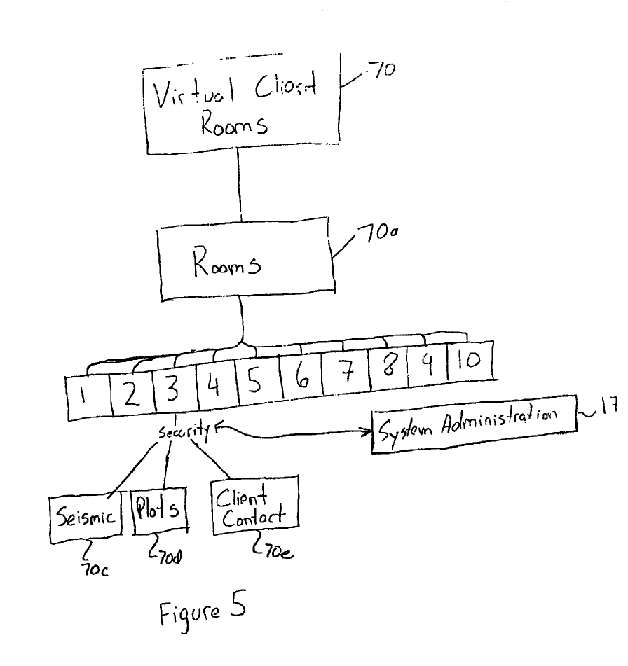

With reference to FIG. 5, within the system 12, the virtual client room module 70 enables the establishment of electronic data rooms 70a on the server 12 dedicated to a particular client is enabled which provide functionality akin to a physical data room. A client may have a specific room 70b assigned to them.

The electronic data room hosts a client's data and is made available for viewing and other purposes by interested and approved parties (potential buyers or partners). The client's data room 70b has viewing rooms 70c, 70d, 70e which may be used by interested parties who have been granted access to evaluate a client's data (for example, seismic or plot data and contact info).

The data can be viewed by one or more parties (who have been granted access) from remote locations. The user (potential buyer for example), after having been granted access, is assigned a specific workplace number (viewing room) to which the data is linked or otherwise made available. The amount of time within that viewing room, and thus the amount of time the data is made available, is controlled by the client and by the system administrator as previously determined.

A user who is granted full access to the data may face several levels of clearance before they can advance to full access, and as such may be screened by the client (seller). Payment (deposit) funds may be required from the viewing party by the client as a show of good faith, or as an indication of interest. Such terms and conditions are set by the client. Other terms and conditions of access are also set by the client and may be made binding by contractual agreement between the parties.

Data can be locked off within a viewing room such that a particular user can access and manipulate (process or interpret) the data privately and confidentially, even while other parties are viewing and working with the same data. All of the data management and viewing functions are available upon request by the data seller. Similarly, the viewing party may be given access to the full range of services and products available over the system in conjunction with the viewing of data.

The identity of the parties involved can remain confidential and anonymous is required, as the interactions run through the system workplace 12 and thus are “offsite” for all parties. Data can be made subject to masking or other mechanisms in order that specifics relating to the identity of the seller are confidential. Similarly, the buyer party in an outright purchase/sale can require that their identity remain hidden. That is, in some transactions, where there will be no ongoing working relationship between the buyer and seller (such as when there is 100% of a prospect or property purchased), there is no need for the parties to know the other's identity, so long as creditworthiness is ascertained and other indices of confidence in the transaction can be assured by a third party.

Such confidentiality and anonymity can also be useful within a bid or auction process.

Listings Journal

The system may also include an electronic listings database (or links to third party listings). The listings journal preferably sets out prospects and properties for sale, with confidentiality and anonymity, if required by the listing party. Each listing is linked to whatever information the listing party may wish to present. Specific types of content will depend upon the nature of the item (prospect or property) being sold, and what type of interest is being marketed (whole or part). The listing party can provide full digitized data or have it converted and formatted by a service provider for hosting on the system. The data need not be hosted on the system itself, even if the listing is set out in the listings journal.

The listings journal is updated or revised at the request of or by the client as circumstances require. For example, as compared to the physical (paper) listings documentation which has traditionally characterized prospect/property sales in the Industry, a change to selling price or related terms, a partial sale of previously listed items, an extension or reduction of offer term, or the addition of further engineering or production information, can easily and cost effectively be achieved where the data is in digital format.

As the listings journal is an electronic database, it can be readily accessed over the internet by remote parties in real or close to real-time. As such, the listings journal has functions of a data broker thereby eliminating a middleman. The interested party simply contacts the seller for further information, whereupon the seller might grant access to the potential buyer/partner in respect of the data pertaining to the listed prospect/property. Again, where the data is on the system and once access has been granted, the interested party can access the data almost immediately.

Business Floors

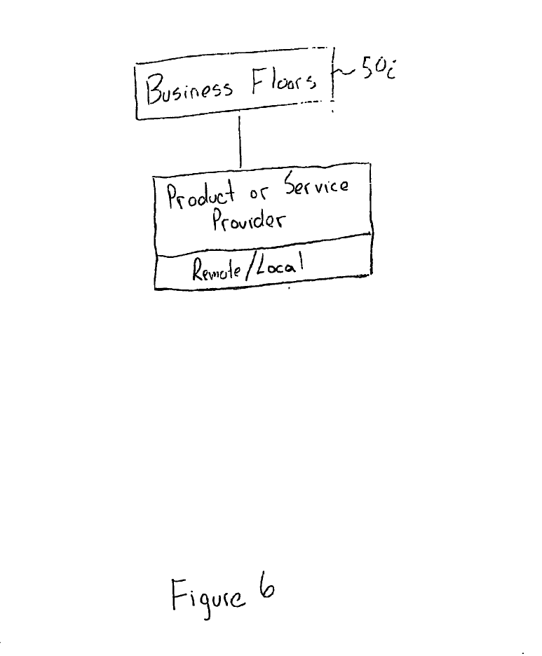

With reference to FIG. 6, the system 12 provides business floors. Business floors 50i are provided to clients who may wish to affiliate themselves with the system as a provider of services or products. The business floor may be set up within the system server 12 or may be a link to the client's website under terms established between the system administrator and service or product provider.

Business floors are linked to other parts of the system as appropriate. For example, a user who requires financial analysis in respect of a transaction might enter the business floor of a service provider linked through the portal marketplace. The user would find the specific business floor through a directory available to them as a system registrant.

### EXAMPLE

As an illustrative example of the use of the system, seismic data company X has a set of raw seismic data which has been acquired but not yet processed; it wishes to arrange the processing of this data through partnership with a processing services company, and then to place the processed data on the market for evaluation and sale by interested parties. X contacts the system administrator to rent a client room within which the data can be placed, with access to the client room controlled by system administrator pursuant to the agreement with X in this regard.

As a registrant and client of the system, X then searches the relevant system business floors for providers of seismic data processing. After negotiating with various service providers, X makes an agreement with service provider B to process the raw data within the client room. B is given access by X, through the necessary security codes; B can either use its own processing software or rent the necessary software from a software provider on a pay per use basis. B has the opportunity to view the raw data before determining which processing software to use, once B has been granted access to the client room by X.

B rents the necessary software from product supplier N, after searching the relevant system business floors and entering into an agreement with N accordingly. B downloads the software to a PC workstation at the place of business of B, through a temporary license granted by N in this regard. B then applies the software to a working (duplicate) copy the data within the client room, leaving the original data intact and secure.

Once B has completed processing the raw data within the client room, it is available for viewing by others, including X and any potential buyers/partners. The processed data is held within the client room, and access is secured accordingly, pursuant to instruction given by X to system administrator.

Payment by X for services received from B, and by B for software received from N, is done by agreement between the parties.

The above-described embodiments of the invention are intended to be examples of the present invention. Alterations, modifications and variations may be effected the particular embodiments by those of skill in the art, without departing from the scope of the invention which is defined solely by the claims appended hereto.

We claim:

1. A system for managing oil and gas industry data and granting a user access to the data over a network comprising:
a database within at least one server operatively connected to the network, the database containing data from at least one customer;
a system administration module for granting the user access rights to a customer's industry data,
wherein the user can access a customer's industry data across the network upon being granted access rights by the system administration module.

2. A system as in claim 1 wherein the system is an internet portal and website, the website including a home page module having operative links to the database and the system administration module.

3. A system as in claim 2 further comprising a virtual client room module operatively linked to the home page enabling a customer's industry data to be graphically located in a specific location on the website.

4. A system as in claim 1 further comprising a project management module operatively linked to the home page enabling a customer to access project management software to control access by third parties and to monitor third party access to the industry data through the system administration module.

5. A system as in claim 1 wherein the wide area network is the internet or an internet or a combination thereof.

6. A system as in claim 1 wherein the system administration module includes at least two levels of access security including a public access level enabling public access to public industry data without system registration and a first access level enabling user access to specific industry data only after system registration.

7. A system as in claim 6 wherein the system administration module includes a third level of access security enabling user access to a customer's industry data after the customer grants access approval to the user.

8. A system as in claim 7 wherein the third level of access is granted after a user has completed a financial transaction with the customer.

9. A system as in claim 1 further comprising industry data viewing and processing software operatively connected to the system to enable a user having access rights to view or process the industry data from a remote location across the network.

10. A system as in claim 2 wherein a third party service or product provider web page is operatively linked to the system.

11. A system as in claim 2 further comprising an industry data processing module operatively linked to the home page enabling a user to access specific software applications for viewing, analysis or interpretation of a customer's industry data.

12. A system as in claim 2 wherein the home page module is operatively linked to any one of or a combination of data software modules including data management, data mapping, data processing, and data viewing software, a virtual client room module, a project management module, a resource module, a business floor module and third party modules including any one of or a combination of professional services, technical services and financial services.

13. A system as in claim 12 wherein the data software modules are remote to the system and a customer or user can access a specific data software module on a pay per use basis.

14. A system as in claim 4 wherein the third parties are any one of or a combination of geologists, geophysicists, engineers, and financiers.

15. A system as in claim 1wherein the system administration module does not identify the identity of parties prior to the completion of a transaction.

16. A system as in claim 3 wherein access to a virtual client room is limited to a specific time by the system administration module.

17. A system as in claim 3 wherein the system administration module enables multiple parties to access industry data within a virtual client room module simultaneously.

18. A system as in claim 1wherein the system administration module enables a transaction to be completed without identification of the parties.

19. A system as in claim 1 wherein the system administration module acts as an intermediary in a financial transaction between a customer and user.

20. A system for promoting the electronic exchange of oil and gas industry data and the completion of transactions within the oil and gas industry across the internet, comprising:
a website having a database in at least one server operatively connected to the internet, the database containing industry data from at least one customer;
a system administration module operatively connected to the website for granting a potential buyer access rights to a customer's industry data, wherein the potential buyer can access a customer's industry data across the internet upon being granted access rights by the system administration module, the system administration module defining at least three levels of access security including a first access level enabling public access to public industry data without system registration, a second access level enabling a potential buyer access to specific industry data only after system registration and a third level of access security enabling the potential buyer access to a customer's industry data after the customer grants access approval to the user upon completion of a financial transaction.

21. A system as in claim 20 wherein the website is operatively linked to any one of or a combination of data software modules including data management, data mapping, data processing, data processing and data viewing software, a virtual client room module, a project management module, a resource module, a business floor module and third party modules including any one of or a combination of professional services, technical services and financial services for enabling the potential buyer to evaluate a customer's industry data through remote access to third party product and service providers.
